(19) United States
(12) Patent Application Publication
(10) Pub. No.: US 2015/0147450 A1
(43) Pub. Date: May 28, 2015

(54) NUTRITIONAL ENHANCEMENT OF PLANT TISSUE VIA SUPERCRITICAL WATER

(71) Applicants: Graham Allan, Kenmore, WA (US); Thomas E. Loop, Seattle, WA (US); James D. Flynn, Auburn, WA (US)

(72) Inventors: Graham Allan, Kenmore, WA (US); Thomas E. Loop, Seattle, WA (US); James D. Flynn, Auburn, WA (US)

(73) Assignee: Xtrudx Technologies, Inc., Seattle, WA (US)

(21) Appl. No.: 14/549,494

(22) Filed: Nov. 20, 2014

Related U.S. Application Data
(63) Continuation-in-part of application No. 13/297,217, filed on Nov. 15, 2011, now Pat. No. 8,980,143.
Application No. 13/297,217 is a continuation-in-part of application No. 12/828,102, filed on Jun. 30, 2010, now Pat. No. 8,057,666.
Application No. 12/828,102 is a continuation-in-part of application No. 12/402,489, filed on Mar. 11, 2009, now Pat. No. 7,955,508.
(60) Provisional application No. 61/906,749, filed on Nov. 20, 2013.

(51) Int. Cl. A23L 1/10; A23L 1/00

(52) U.S. Cl. CPC A23L 1/1025; A23L 1/0076; A23V 2002/00
USPC 426/507

(57) ABSTRACT

A method for enhancing the nutritional value of plant tissue by reaction with supercritical water is disclosed. The method comprises: conveying a selected plant tissue material through an extruder, wherein the extruder is configured to continuously convey the plant tissue material to a supercritical fluid reaction zone; injecting hot compressed water into the supercritical fluid reaction zone, while the extruder is conveying the selected plant tissue material into the supercritical fluid reaction zone so as to yield a mixture; retaining the mixture within the reaction zone for a period of time sufficient to yield a plurality of plant tissue reaction products. The reaction zone may be characterized by a tubular reactor having an adjustably positionable inner tubular spear, wherein the tubular reactor and the inner tubular spear further define an annular space within the reaction zone, and wherein the mixture flows through the annular space and into a reaction products chamber or vessel.

### CROSS-REFERENCE TO RELATED APPLICATIONS

This application is a continuation-in-part of U.S. application Ser. No. 13/297,217 filed on Nov. 15, 2011 (allowed), which application claims the benefit of priority to U.S. application Ser. No. 12/828,102 filed on Jun. 30, 2010 (now U.S. Pat. No. 8,057,666) and U.S. application Ser. No. 12/402,489 filed on Mar. 11, 2009 (now U.S. Pat. No. 7,955,508), which applications claims the benefit of priority to U.S. Provisional Application No. 61/035,380 filed on Mar. 11, 2008 and U.S. Provisional Application No. 61/110,505 filed on Oct. 31, 2008, which applications are all incorporated herein by reference in their entireties for all purposes. This application also claims the benefit of priority to U.S. Provisional Application No. 61/906,749 filed on Nov. 20, 2013.

### TECHNICAL FIELD

The present invention relates generally to biomass treatment and conversion systems and, more specifically, to methods of enhancing the nutritional value of plant tissue by reaction with hot compressed and/or supercritical water.

### BACKGROUND OF THE INVENTION

All plants that are consumed for animal nutrition consist mainly of polymeric structures which comprise proteins, polysaccharides and polyphenols. In order to function as nutrients, these giant macromolecules must be broken down into smaller chemical structures. While the animal can accomplish this breakdown for much of the feedstuff by digestion the animal cannot do it completely.

Cereal crops represent the major source of food for agricultural monogastric animals, such as swine and poultry. Among these crops, corn predominates. A consensus among experts is that corn is the best crop in terms of food calories generated per acre of suitable farmland. Besides, both corn harvesting and its feeding to animals are processes that can be easily mechanized.

Unfortunately, in the last few years, the cost of corn for agricultural businesses has doubled as a result of higher prices of corn production, increased demand, lack of additional arable land for new production, and transportation cost. The burden of the increased cost of corn on businesses growing agricultural animals has forced them to look for strategies that would offset this increase. One approach, always ongoing, is to enhance the efficiency of corn production by creating improved, higher-yield, corn cultivars. These improvements may target not only general “agricultural” characteristics, such as resistance to biotic and abiotic stresses, but also traits responsible for caloric value of corn grains.

Another approach to reduce the cost of feeding animals with corn would be increasing the digestibility of corn grains. A “typical” diet to feed pigs includes 75% corn, 5% baked products (bread, cookies, etc.), 15-17% soybean, and 3-5% of vitamins, minerals and synthetic amino acids. The digestibility of the corn in this mixture is 91-92%. If a procedure could be developed to increase the digestibility to even 95-96%, this would result in significant cost savings.

Yet another approach would be looking for other plants potentially capable of producing high-yielding, high-energy plant tissue that could provide an alternative to corn. The idea behind this approach is to identify commercially viable crops whose nutrition value could be increased by chemical treatment and/or mechanical processing. Obviously, the realization of this approach would require identification of commercially viable methods of increasing the digestibility of lower-energy (high-fiber, low carbohydrate, low fat) plant tissues.

To this end, researchers have long sought chemical and/or mechanical treatment methods capable of improving and/or enhancing the digestible energy value of plant tissues for monogastric (non-ruminant) animals, including chemical/biochemical ways to increase grain energy digestibility (for example, by using enzymes) and mechanical/physical ways of treating grain.

One of the most intriguing and environmentally sound approaches to breaking down molecules is simply to use water alone, heated to its supercritical state. About a decade ago this chemical-free technology was comprehensively discussed in an English language review by P. E. Savage (Chem. Rev. 1999, 99, 609). Since then few modern reviews have appeared. However, numerous articles, mostly from Japan and China, have appeared each year dealing with the reactive power of supercritical water. All of these publications emphasize that when water is heated to 374.4 C or above, the pressure concomitantly generated is 217.7 atm and above. The water then becomes a powerful new reactive solvent. Temperatures above 400 C seem to make the water even more effective in its new role. For example, it now dissolves nonpolar substances such as oils and fats.

These and numerous other similar reactions (J. A. Onwudili & P. T. Williams, Chemosphere 2009, 74(6), 787) demonstrate clearly that chemical bonds can be broken down by treatment with supercritical water only, without the use of any catalysts. Apparently the water and substrates may undergo the water gas reaction and hydrogen is released to combine with the molecular fragments from the substrates. This has actually been demonstrated by the use of deuterium oxide in place of water and the consequent finding of deuterium in the fragments. However, since nearly all water-substrate reactions have been run in a batch mode on a very small scale, the chemistry so elegantly elucidated does not provide answers to the questions necessary for the future development of a commercially-sized, practical, continuous, supercritical water-based process.

Accordingly, and although some progress has made with respect to the development of biomass treatment and conversion systems, there is still a need in the art for new and improved methods for enhancing the nutritional value of plant tissue. The present invention fulfills these needs and provides for further related advantages.

### SUMMARY OF THE INVENTION

The present invention in one embodiment is directed to a new method of enhancing the nutritional value of plant tissue by increasing the digestibility of energy (carbohydrates, fiber, fat) from cereal grains and lower-energy crops (i.e., plant tissues) by treatment with supercritical water. The innovative method of the present invention comprises at least the following steps: conveying a selected plant tissue through an extruder (single or twin screw) so as to define a selected plant tissue material flowstream, wherein the extruder is configured to continuously convey the selected plant tissue material from an upstream inlet to a supercritical fluid reaction zone; injecting hot compressed water into the supercritical fluid reaction zone while the extruder is conveying the selected plant tissue material flowstream into the supercritical fluid reaction zone so as to yield a mixture; retaining the mixture within the reaction zone for a period of time (e.g., from about 0.4 to about 10 seconds) sufficient to yield a plurality of plant issue reaction products (that are more digestible by animals), wherein the reaction zone is defined by a tubular reactor shell having an inner tubular spear, wherein the tubular reactor and the inner tubular spear further define an annular space within the reaction zone, and wherein the mixture flows through the annular space (and wherein the inner tubular spear is adjustably movable in back and forth directions within the tubular reactor so as to selectably increase or decrease the volume of the reaction zone); and expelling the plurality of plant tissue reaction products out of the supercritical fluid reaction zone and into a reaction products chamber or vessel.

These and other aspects of the present invention will become more evident upon reference to the following detailed description and accompanying drawings. It is to be understood, however, that various changes, alterations, and substitutions may be made to the specific embodiments disclosed herein without departing from their essential spirit and scope.

### BRIEF DESCRIPTION OF THE DRAWINGS

The drawings are intended to be illustrative and symbolic representations of certain exemplary embodiments of the present invention and as such they are not necessarily drawn to scale. In addition, it is to be expressly understood that the relative dimensions and distances depicted in the drawings are exemplary and may be varied in numerous ways. Finally, like reference numerals have been used to designate like features throughout the views of the drawings.

FIG. 1 shows a side elevational cross-sectional view of an extruder-fed induction-heated supercritical fluid conversion machine useful for enhancing the nutritional value of plant tissue in accordance with an embodiment of the present invention.

FIG. 2 shows a partial cross-sectional view of a supercritical fluid reaction zone defined by a spear-and-tube reactor useful for enhancing the nutritional value of plant tissue in accordance with an embodiment of the present invention.

### DETAILED DESCRIPTION OF INVENTION

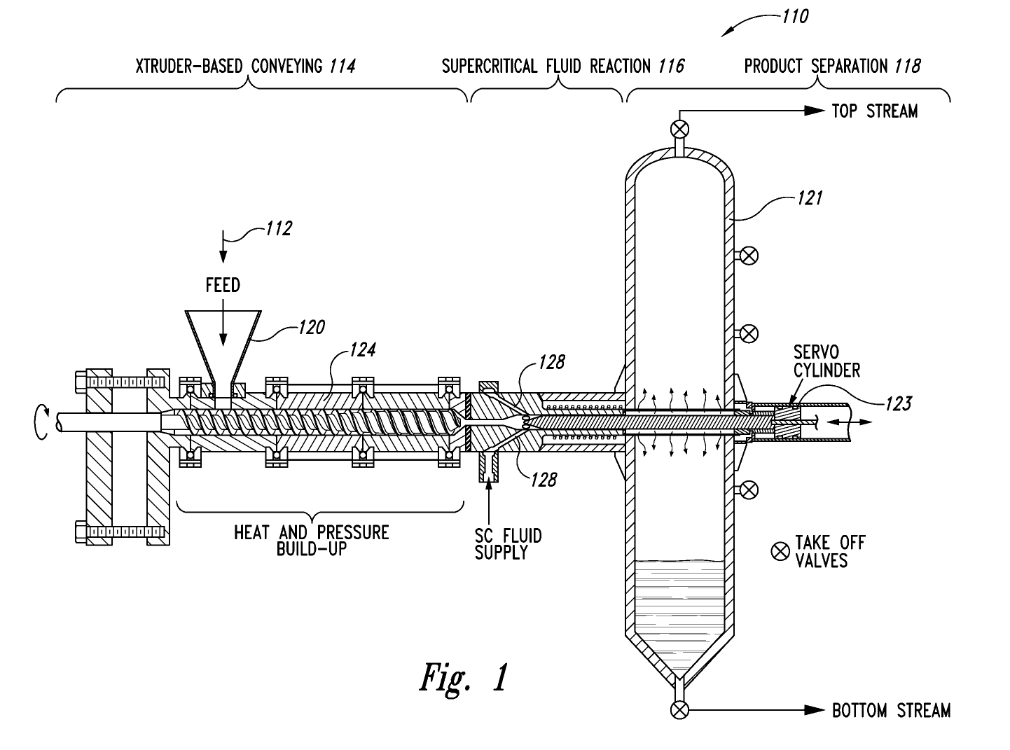

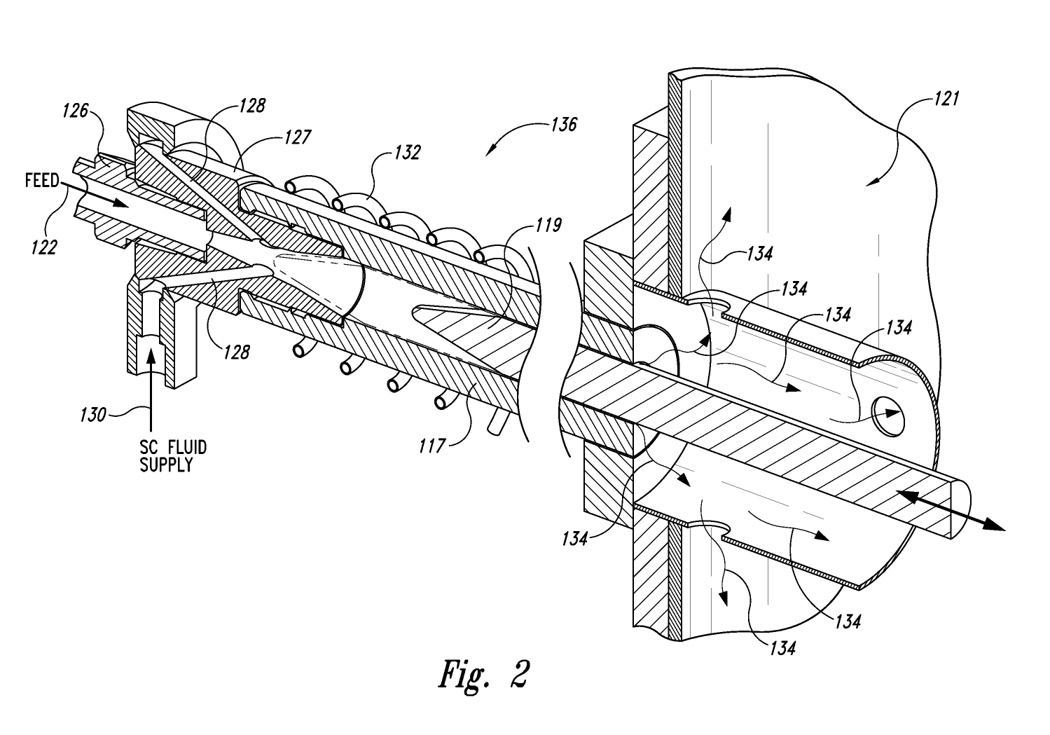

Referring now to the drawings where like numerals have been used to designate like features throughout the views, and more specifically to FIGS. 1 and 2, the present invention in one embodiment is directed to a method that involves use of a supercritical fluid conversion machine/system 110 capable of converting a selected plant tissue material 112 (e.g., undried and wet feedstuff such as, for example, corn, baked products, soy beans, etc.) into a plurality of plant tissue reaction products (not shown) that are more digestible by animals. In the context of the present invention, the term “plant tissue” means any biomass or plant-derived organic matter.

As shown, the supercritical fluid conversion machine/system 110 useful for carrying out the methods of the present invention comprises, in fluidic series, three discreet zones: namely, (1) an extruder-based conveying zone 114; (2) a supercritical fluid reaction zone 116; and (3) a plant tissue reaction products separation zone 118.

In accordance with the novel approach of the present invention, a specialized extruder conveys the selected plant tissue materials 112 from an upstream hopper 120 to the downstream supercritical fluid reaction zone 116, while increasing the pressure from about atmospheric to greater than about 3,200 psi. The extruder-based approach is important because it enables the conveyance of near-solid materials (as opposed to conventional slurry pumping technologies used in the prior art). The heated and pressurized plant tissue materials 122 exit the extruder 124 through a specialized die 126 connected to a manifold 127 that includes a plurality of circumferentially positioned supercritical fluid injection channels 128 configured to inject hot compressed water 130 (or other fluid) into the supercritical fluid reaction zone 116.

In a preferred embodiment, hot compressed water 130 is injected into the supercritical fluid reaction zone 116 by way of the injection channels 128 while the extruder 124 is conveying the selected plant tissue materials 112 into the supercritical fluid reaction zone 116 so as to yield a mixture (not shown). The supercritical fluid reaction zone 116 further heats the flowing and pressurized plant tissue materials 122 and hot compressed water 130 mixture to conditions at or above supercritical by means of a circumferentially positioned, high efficiency alternating current induction coil 132 (which, in turn, is connected to an induction heater (not shown)) to thereby yield the plurality of plant tissue reaction products 134. The resulting plant tissue reaction products 134 are then conveyed through a highly innovative spear-and-tube reactor 136.

As best shown in FIG. 2, the spear-and-tube reactor 136 useful for carrying out the methods of the present invention allows a controlled and/or minimal amount of supercritical water to enter into the system (i.e., preferably less than about 100% to about 20% by weight basis). More specifically, the reaction zone 116 is defined by a tubular reactor shell 117 having an inner tubular spear 119, wherein the tubular reactor shell 117 and the inner tubular spear 119 further define an annular space within the reaction zone. As shown, the plant tissue materials 122 and hot compressed water 130 interactions yield the plurality of plant tissue reactions products 134 that flow through the annular space and are expelled into an innovative expansion/separation chamber 121. As further shown, the inner tubular spear 119 is adjustably movable in back and forth directions within the tubular reactor shell 117 by means of a servo cylinder 123 so as to selectable increase or decrease the volume of the reaction zone.

Without necessarily prescribing to any particular scientific theory, it is believed that at supercritical conditions the water component is at a supercritical state, thereby enabling (in the context of a selected plant tissue) the rapid cleavage of the giant macromolecules of the plant tissue (mainly proteins, polysaccharides, and polyphenols) into smaller chemical structures that tend to be more digestible by virtue of having more sites accessible to enzymic attack. In other words, nutritional enhancement occurs because various linkages within the plant tissues are cleaved creating more molecular chain ends thus making the tissues more accessible to the digestive enzymes of the animal. Moreover, the tissue-stiffening, inter-ring linkages in plant phenols are also believed to be cleaved. Furthermore, since supercritical water is a powerful solvent, the coherent areas of digestion-resistant crystallinity within the plant tissues are also disrupted.

The present invention is also directed to a method for converting selected plant tissues into a plurality of reaction products that are more digestible to animals. Accordingly, and in another embodiment, a method of the present invention comprises the steps of: providing an elongated conveying zone that contains one or more elongated rotatable shafts having a plurality of flighted screws positioned lengthwise within an elongated conveying section housing, wherein the plurality of flighted screws are positioned about each respective of the one or more elongated rotatable shafts, and wherein the one or more elongated rotatable shafts are configured to continuously convey the selected plant tissue (optionally together with water or other liquid) from an upstream inlet to a supercritical fluid reaction zone while increasing the pressure of the selected plant tissue from about atmospheric at the inlet to greater than about 22.1 MPa at the supercritical fluid reaction zone; conveying a mixture of the selected plant tissue material through the elongated conveying zone and into the supercritical fluid reaction zone; heating and further pressurizing the mixture within the supercritical fluid reaction zone, while injecting hot compressed and/or supercritical water into the supercritical fluid reaction zone, to yield a plurality of plant tissue reaction products, wherein heat energy is supplied by means of an induction heating coil positioned circumferentially about the supercritical fluid reaction zone; retaining the mixture within the supercritical fluid reaction zone for a period of time sufficient to yield the plurality of plant tissue reaction products; expelling the plurality of plant tissue reaction products out of the supercritical fluid reaction zone and into a separation zone; and separating the plurality of plant tissue reaction products into at a liquid fraction and a solid fraction.

In this method, the period of time that the plant tissue mixture is retained within the supercritical fluid reaction zone generally ranges from about 0.4 to about 10 seconds (but may include much greater periods of time up to a few minutes in duration).

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A method for enhancing the nutritional value of plant tissue, the method comprising the steps of:
conveying a selected plant tissue material through an extruder so as to define a selected material flowstream, wherein the extruder is configured to continuously convey the selected plant tissue material from an upstream inlet to a supercritical fluid reaction zone;
injecting hot compressed water into the supercritical fluid reaction zone while the extruder is conveying the selected plant tissue material flowstream into the supercritical fluid reaction zone so as to yield a mixture;
retaining the mixture within the reaction zone for a period of time sufficient to yield a plurality of plant tissue reaction products, wherein the reaction zone is defined by a tubular reactor having an inner tubular spear, wherein the tubular reactor and the inner tubular spear further define an annular space within the reaction zone, and wherein the mixture flows through the annular space; and
expelling the plurality of plant tissue reaction products out of the supercritical fluid reaction zone and into a reaction products chamber or vessel.

2. The method of claim 1 wherein the selected plant tissue is corn.

3. The method of claim 2 wherein the extruder is a single screw extruder.

4. The method of claim 2 wherein the hot compressed water is supercritical water.

5. The method of claim 4 wherein the hot compressed water is in amount that is less than the amount of the selected plant tissue material on a weight percent basis.

6. The method of claim 2 wherein the period of time ranges from about 0.4 to about 10 seconds.

7. The method of claim 2 wherein the inner tubular spear is adjustably movable in back and forth directions within the tubular reactor so as to selectable increase or decrease the volume of the reaction zone.
